(19) United States
(12) Patent Application Publication
(10) Pub. No.: US 2013/0107411 A1
(43) Pub. Date: May 2, 2013

(54) DRIVING CIRCUIT WITH OUTPUT PROTECTION AND DRIVING PROTECTION CIRCUIT APPLIED TO THE SAME

(71) Applicants: Ke PENG, Wuxi (CN); Li-Min LEE, New Taipei City (TW); Chung-Che YU, New Taipei City (TW); Shian-Sung SHIU, New Taipei City (TW)

(72) Inventors: Ke PENG, Wuxi (CN); Li-Min LEE, New Taipei City (TW); Chung-Che YU, New Taipei City (TW); Shian-Sung SHIU, New Taipei City (TW)

(73) Assignee: GREEN SOLUTION TECHNOLOGY CO., LTD., New Taipei City (TW)

(21) Appl. No.: 13/287,133

(22) Filed: Nov. 2, 2011

(51) Int. Cl. H02H 9/04

(52) U.S. Cl. 361/91.3

(57) ABSTRACT

A driving circuit controls a driving signal according to a control signal at a first or second logic level for driving a load. A driving protection circuit includes a driving signal detection circuit for generating a load error signal in response to that a load is abnormal; a delay judgment circuit coupled to the driving signal detection circuit for generating a first signal in response to that the load has been abnormal for a predetermined time period; and a logic control circuit coupled to the delay judgment circuit and the driving circuit for determining whether to modulate the driving signal according to the first signal. When the control signal has been at the first logic level and the load has been abnormal for the predetermined time period, the logic control signal modulates the driving signal to be a level corresponding to the control signal at the second logic level.

### BACKGROUND OF THE INVENTION

(1) Field of the Invention

This invention relates to a driving circuit and a driving protection circuit thereof, and more particularly relates to a driving circuit with output protection and a driving protection circuit thereof.

(2) Description of the Prior Art

FIG. 1 is a circuit diagram of a typical driving circuit, which includes a clock signal generator 10 and a driving-stage circuit 20 for driving a load 30. The clock signal generator 10 generates an original driving signal Sc, which is then amplified by the driving-stage circuit 20 for enhancing driving capability such that a driving signal Sdr is generated to drive the load 30. The waveform of the driving signal Sdr is identical to that of the original driving signal Sc under a normal operation, but may be drawn up or down when the load 30 is short-circuited or overloaded. Thus, the current Ic or Idc provided by the driving-stage circuit 20 may exceed a spec of the circuit design to cause the driving-stage circuit 20 to be burned.

### SUMMARY OF THE INVENTION

Since the driving circuit provided in prior art may be burned because of short-circuited or overloaded condition, a driving protection circuit is provided in the present invention. The driving protection circuit detects the level of the driving signal outputted by the driving circuit, and forces the driving circuit to stop outputting a driving signal when the detected level of the driving signal shows abnormal conditions so as to prevent the driving circuit from being burned by the large output power.

For the aforementioned object, a driving protection circuit is provided in the present invention. The driving protection circuit is utilized for protecting a driving circuit which controls a level of a driving signal based on a logic level of a control signal having a first logic level and a second logic level for driving a load. The driving protection circuit comprises a driving signal detecting circuit, a delay judging circuit, and a logic control circuit. The driving signal detecting circuit is used for detecting the level of the driving signal and generating a load error signal representing an abnormal condition of the load. The delay judging circuit is coupled to the driving signal detecting circuit for generating a first signal when the load error signal represents that the load has the abnormal condition lasting longer than a predetermined time period. The logic control circuit is coupled to the delay judging circuit and the driving circuit for deciding whether to adjust the level of the driving signal or not according to the first signal. The logic control circuit adjusts the level of the driving signal to a level corresponding to the control signal at the second logic level when the control signal is at the first logic level and the load has the abnormal condition lasting longer than the predetermined timed period.

A driving circuit with output protection is also provided in the present invention. The driving circuit includes a control circuit, a driving-stage circuit, and a driving protection circuit. The control circuit is used for generating a control signal, which has a first logic level and a second logic level. The driving-stage circuit is used for generating a driving signal and controlling a level of the driving signal with respect to the logic level of the control signal for driving a load. The driving protection circuit is coupled to the control circuit and the driving stage circuit for determining whether the driving signal which is lower than a first predetermined level lasts longer than a predetermined time period or not when the control signal is at the first logic level. If so, the driving protection circuit controls the driving stage circuit to adjust the level of the driving signal to a level corresponding to the control signal at the second logic level.

Another driving circuit with output protection is also provided in the present invention. The driving circuit has a control circuit, a driving-stage circuit, and a driving protection circuit. The control circuit generates a control signal, which has a first logic level and a second logic level. The driving-stage circuit is used for generating a driving signal and controls a level of the driving signal with respect to the logic level of the control signal for driving a load. The driving protection circuit is coupled to the control circuit and the driving stage circuit for determining whether the driving signal which is higher than a second predetermined level lasts longer than a predetermined time period or not as the control signal is at the second logic level. If so, the driving protection circuit controls the driving stage circuit to adjust the level of the driving signal to a level corresponding to the control signal at the second logic level.

### BRIEF DESCRIPTION OF THE DRAWINGS

The present invention will now be specified with reference to its preferred embodiment illustrated in the drawings, in which:

FIG. 1 is a circuit diagram of a typical driving circuit;

FIG. 2 is a block diagram showing a driving circuit in accordance with a first embodiment of the present invention;

FIG. 3 is a circuit diagram showing the electric circuit for implementing the driving circuit of FIG. 2;

FIG. 4 is a diagram showing the waveforms of the signals described in the embodiment shown in FIG. 3;

FIG. 5 is a circuit diagram of a driving circuit in accordance with a second embodiment of the present invention; and

FIG. 6 is a circuit diagram of a driving circuit in accordance with a third embodiment of the present invention.

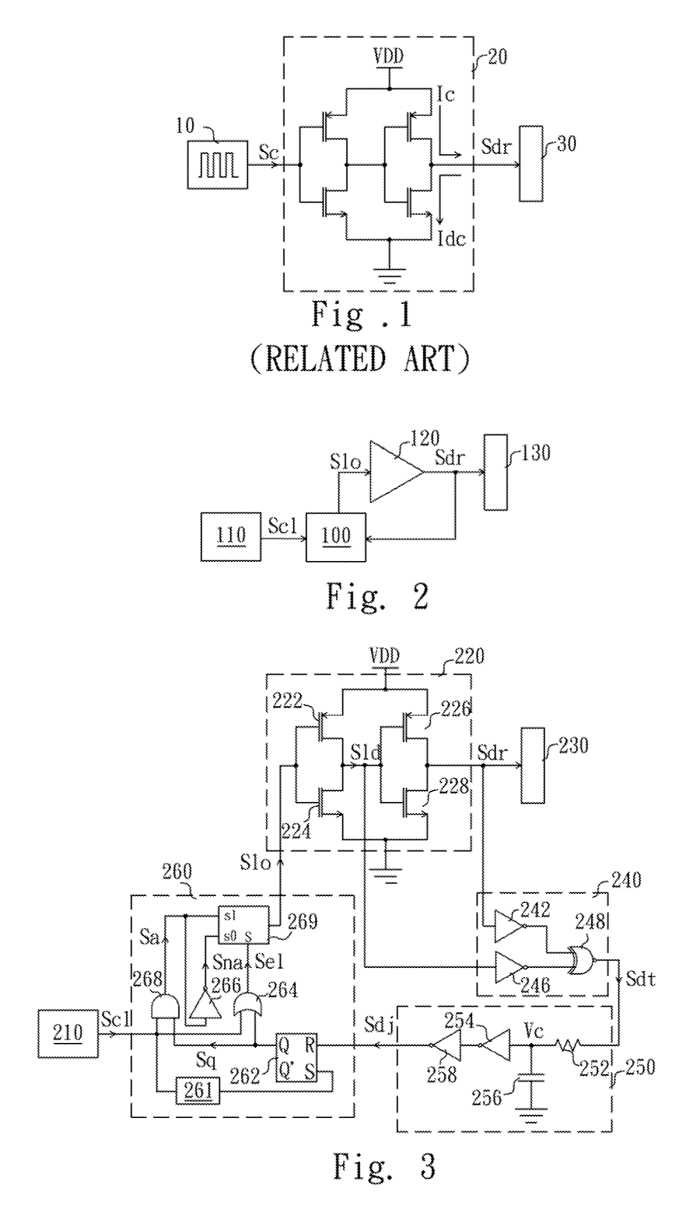

### DESCRIPTION OF THE PREFERRED EMBODIMENT

FIG. 2 is a block diagram showing a driving circuit in accordance with a first embodiment of the present invention. As shown in FIG. 2, the driving circuit includes a control circuit 110, a driving-stage circuit 120, and a driving protection circuit 100 and is utilized for generating a driving signal Sdr to drive a load 130. The control circuit 110 may generate a control signal Scl, which is configured to show a first logic level and a second logic level, for example, logic levels of “0” and “1”. The driving protection circuit 100 may determine whether the driving circuit is normally operated according to the control signal Scl and the driving signal Sdr. When the driving circuit is normally operated, the driving protection circuit 100 generates the logic control signal Slo according to the control signal Scl so as to control the driving-stage circuit 120 to generate the driving signal Sdr with respect to the logic level of the control signal Scl. For example, when the control signal Scl is at the first logic level, the high level driving signal Sdr is generated; and when the control signal Scl is at the second logic level, the low level driving signal Sdr is generated.

In case a short circuit occurs between the load 130 and a power source (not shown), the driving signal Sdr shows an abnormally high level when the control signal Scl is at the second logic level. On the other hand, in case a short circuit occurs between the load 130 and a ground or the load 130 is overloaded, the driving signal Sdr shows an abnormally low level when the control signal Scl is at the first logic level. When the driving protection circuit 100 determines that the aforementioned abnormal conditions lasts longer than a predetermined time period, the driving protection circuit 100 may generate and provides the logic control signal Slo to the driving-stage circuit 120 according to the logic level of the control signal Scl, so as to control the driving-stage circuit 120 to change the level of the driving signal Sdr, thereby prohibiting the continuous occurrence of abnormal condition. The detail operations are described below.

When the control signal Scl is at the first logic level and the driving signal Sdr lower than a first predetermined level lasts longer than a predetermined time period, representing that the load may be short circuited with respect to ground or overloaded, the driving-stage circuit 120 changes the driving signal Sdr to a low level with respect to the second logic level of the control signal Scl, thereby preventing the risk of damage due to the overlarge power continuously provided by the driving-stage circuit 120 that attempts to increase the level of the driving signal Sdr. When the control signal Scl is at the second logic level and the driving signal Sdr higher than a second predetermined level lasts longer than a predetermined time period, representing that the load may be short circuited with respect to the power source, the driving-stage circuit 120 changes the driving signal Sdr to a high level with respect to the first logic level of the control signal Scl, thereby preventing the risk of damage due to the overlarge power continuously provided by the driving-stage circuit 120 that attempts to lower the level of the driving signal Sdr. As mentioned above, the length of the predetermined time period may be decided according to the maximum tolerable current or/and the maximum power of the driving-stage circuit 120 to prevent the driving-stage circuit 120 from being damaged due to the insufficiency of current withstanding ability or thermal dissipation ability. In addition, the setting of the predetermined time period may also prevent misjudgment due to noise or time delay of circuit operation.

The driving protection circuit in the present invention may selectively provide the detection and protection functions for one or both of the aforementioned abnormal conditions to achieve the object of protecting driving circuit according to actual applications.

FIG. 3 is a circuit diagram showing the driving circuit in FIG. 2 in detail. As shown in FIG. 3, the driving circuit includes a control circuit 210, a driving-stage circuit 220, and a driving protection circuit and is utilized for generating a driving signal Sdr to drive a load 230. The driving protection circuit includes a driving signal detecting circuit 240, a delay judging circuit 250, and a logic control circuit 260. The driving circuit may be applied to the switching controller of an ordinary switch power supply, such as a pulse width modulation controller, a pulse frequency modulation controller, a constant on time controller, a constant off time controller, etc., for driving an integrated transistor switch or an outside transistor switch to prevent the abnormal condition of the transistor switch from damaging the controller.

In the present embodiment, the driving-stage circuit 220 includes P-type MOSFETs 222 and 226 and N-type MOSFETs 224 and 228. The P-type MOSFET 222 and the N-type MOSFET 224 are serially connected between a power source VDD and a ground to form a first driving unit. The P-type MOSFET 226 and the N-type MOSFET 228 are serially connected between the power VDD and a ground to form a second driving unit. The gate electrodes of the P-type MOSFET 222 and the N-type MOSFET 224 are coupled to the logic control circuit 260 for accessing the logic control signal Slo. The junction between the P-type MOSFET 222 and the N-type MOSFET 224 is coupled to the gate electrodes of the P-type MOSFET 226 and the N-type MOSFET 228. The states of the P-type MOSFET 222 and the N-type MOSFET 224 controlled by the logic control signal Slo will be opposite to each other, i.e., one is turned on and the other is turned off, and a second signal Sld is generated at the junction between the two MOSFETs 222 and 224. The states of the P-type MOSFET 226 and the N-type MOSFET 228 controlled by the second signal Sld will be opposite with each other, and the driving signal Sdr is generated. Under a normal operation, the waveform of the driving signal Sdr is substantially identical to that of the control signal Scl but is inverted in phase to the second signal Sid.

The driving signal detecting circuit 240 includes two inverters 242 and 246 and an XNOR gate 248, and is utilized for detecting the level of the driving signal Sdr to generate a load error signal Sdt. The input of the inverter 246 receives the second signal Sld, and the output of the inverter 246 is coupled to the input of the XNOR gate 248. The input of the inverter 242 receives the driving signal Sdr, and the output of the inverter 242 is coupled to the input of the XNOR gate 248. The logic outputs of the inverters 242 and 246 in the driving signal detecting circuit 240 may be utilized for determining whether the circuit is normally operated or not. That is, under a normal operation, the second signal Sld and the driving signal Sdr are inverted in phase, and thus the XNOR gate 248 outputs a low level load error signal Sdt. In contrast, since the driving signal Sdr cannot be completely drawn high or low under an abnormal operation, the output signals of the inverter 242 and the inverter 246 will be both high or low and thus the XNOR gate 248 will output a high level load error signal Sdt.

The delay judging circuit 250 includes a resistor 252, a delaying capacitor 256, and inverters 254 and 258 and is utilized for determining whether the high level load error signal Sdt, which indicates the abnormal condition, lasts longer than a predetermined time period or not, and accordingly generating a first signal Sdj. Under a normal operation, the driving signal detecting circuit 240 generates the low level load error signal Sdt, and thus the inverter 254 outputs the low level first signal Sdj. However, as the load has abnormal conditions, the driving signal detecting circuit 240 generates the high level load error signal Sdt to charge the delaying capacitor 256 through the resistor 252, and thus the capacitor voltage Cv is increased. If the high level state of the load error signal Sdt is resulted from noise or merely from a time delay of circuit operation, for example, transmission time delay of the second signal Sld and the driving signal Sdr due to the parasitic capacitor in the MOSFET, the duration of the high level state will not last longer than the predetermined time period, and the load error signal will be back to the low level again. Namely, the resistor 252, the delaying capacitor 256 and the inverter 254 serve as a timing unit for determining whether the abnormal condition lasts longer than the predetermined time period. If the high level load error signal Sdt lasts longer than the predetermined time period, the capacitor voltage Cv of the delaying capacitor 256 may exceed the logic determining level of the inverter 254 and the high level first signal Sdj is outputted.

The logic control circuit 260 is coupled to the control circuit 210, the delay judging circuit 250, and the driving-stage circuit 220, and includes an rising/falling edge detecting circuit 261, a RS flip-flop 262, an OR gate 264, an inverter 266, an AND gate 268, and a multiplexer 269. The logic control circuit 260 may adjust the level of the driving signal outputted by the driving-stage circuit 220 to prevent the continuation of the abnormal condition from damaging the circuit when the high level first signal Sdj shows that the load 230 has abnormal conditions lasting longer than the predetermined time period, is received.

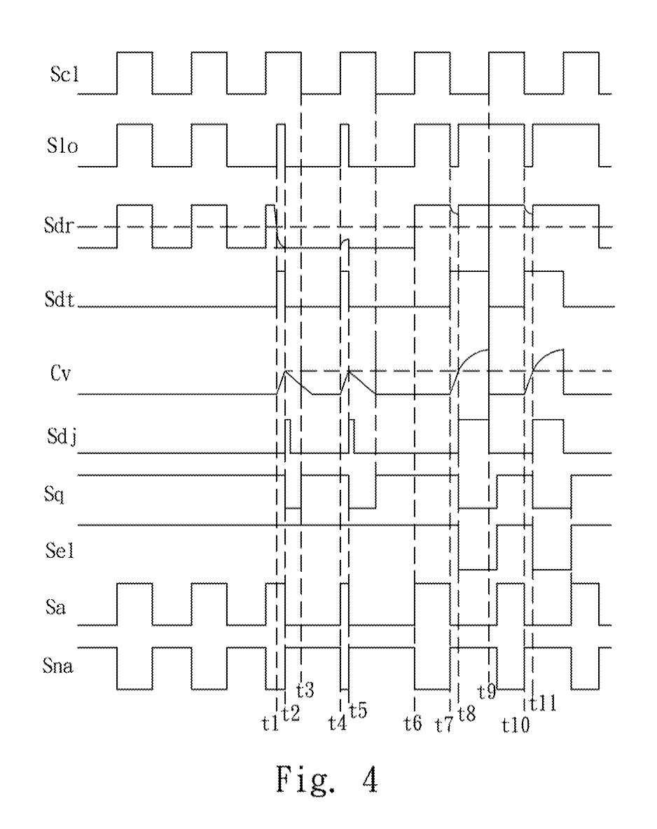

For a better understanding of the operation of the present embodiment, please also refer to FIG. 4, which shows the waveforms of signals described in the embodiment shown in FIG. 3. As shown in FIG. 4, the reset input R of the RS flip-flop 262 is coupled to the output of the inverter 254 in the delay judging circuit 250, and the set input S is coupled to the rising/falling edge detecting circuit 261. The rising/falling edge detecting circuit 261 is coupled to the control circuit 210, and generates and provides a pulse signal to the set input S of the RS flip-flop 262 to enable the output Q of the RS flip-flop 262 to output a high level third signal Sq again when the rising edge and the falling edge of the control signal Scl is detected. As shown in FIG. 4, before the time point t1, the driving circuit is normally operated, and the first signal Sdj remains at low, and thus the RS flip-flop 262 outputs the high level third signal Sq at the output Q. The OR gate 264 receives the third signal Sq and the control signal Scl, and generates a selecting signal Sel accordingly. At this time, since the third signal Sq is at the high level, the OR gate 264 outputs the high level selecting signal Sel to enable the multiplexer 269 to select a fourth signal Sa received at a first selecting input end s1 as the logic control signal Slo. In addition, the AND gate 268 receives the third signal Sq and the control signal Scl, and generates and provides the fourth signal Sa to the first selecting input s1 of the multiplexer accordingly. Since the third signal Sq is at the high level, the fourth signal Sa will be identical to the control signal Scl and the fourth signal Sa will be identical to the logic control signal Slo. Thus, it can be said that the driving-stage circuit 220 generates the driving signal Sdr according to the control signal Scl.

However, when the load 230 is short-circuited with respect to ground or the load 230 is overloaded, the driving signal Sdr will be high when the logic level of the control signal Scl is high. Referring to FIG. 4, at the time point t1, the load 230 has abnormal conditions such as short-circuited with respect to ground or overloaded, and the driving signal Sdr is drawn down to a level below the logic determining level of the inverter 242. Thus, both the inverters 242 and 246 output the high level signal to enable the XNOR gate 248 to generate the high level load error signal Sdt. After the predetermined time period, the capacitor voltage Cv exceeds the logic determining level of the inverter 254, and the delay judging circuit 250 generates the high level first signal Sdj at the time point t2. Meanwhile, the RS flip-flop 262 receives the first signal Sdj and generates the low level third signal Sq. Before the time point t3, the logic level of the control signal Scl remains high and the OR gate 264 outputs the high level selecting signal Sel to enable the multiplexer 269 to select the fourth signal Sa as the output signal. In the period between time points t2 and t3, the fourth signal Sa generated by the AND gate 268 is low to enable the driving-stage circuit 220 to draw down the level of the driving signal Sdr to prevent the continuous large power output of the driving-stage circuit 220. At this time, since the logic control signal Slo is changed to the low level, the inverters 242 and 246 output logic signals with opposite phases so as to enable the driving signal detecting circuit 240 to output the low level load error signal Sdt. In addition, the delaying capacitor 256 begins to be discharged at the time point t2 to enable the delay judging circuit 250 to output the low level first signal Sdj. At the time point t3, the logic level of the control signal Scl is changed to low. The rising/falling edge detecting circuit 261 is triggered by the level change of the control signal Scl, so as to generate pulse signals to enable the output Q of the RS flip-flop 262 to output the high level third signal Sq again. Thus, in the period between time points t3 and t4, which is corresponding to the logic low level period of the control signal Scl, the OR gate 264 still outputs the high level selecting signal Sel even when the logic level of the control signal Scl is low, such that the multiplexer 269 selects the control signal Scl as the logic control signal Slo. At time points t5 and t6, the short-circuit condition or the overloaded condition has not been recovered, and thus the operations at time points t1 and t2 will be repeated.

In the period between time points t6 and t7, the driving circuit is temporarily recovered to be normal. However, at the time point t7, the load 230 has a short circuit with respect to the power source. The level of the driving signal Sdr, which should be at low because of the low level control signal Scl, is drawn up because of the abnormal conditions, such that the XNOR gate 248 outputs the high level load error signal Sdt. After the predetermine time period, the capacitor voltage Cv exceeds the logic determining level of the inverter 254, and thus the delay judging circuit 250 generates the high level first signal Sdj at the time point t8. At this time, the high level first signal Sdj triggers the RS flip-flop 262 to generate the low level third signal Sq. Since the logic level of the control signal Scl is low before time t9, the OR gate 264 outputs the low level selecting signal Sel to enable the multiplexer 269 to select a fifth signal Sna from a second selecting input end s0 as the logic control signal Slo. The input of the inverter 266 is coupled to the output of the OR gate 268, and the output of the inverter 266 is coupled to the second selecting input end s0 of the multiplexer 269. Meanwhile, since the logic level of the control signal Scl is low and the third signal Sq is low, the inverter 266 outputs the high level fifth signal Sna. Therefore, the logic control signal Slo outputted from the multiplexer 269 stays high to prevent the continuous large power output of the driving-stage circuit 220. At this time, because the logic control signal Slo is high, the inverters 242 and 246 output signals with opposite phases to enable the driving signal detecting circuit 240 to output the low level load error signal Sdt. In addition, the delaying capacitor 256 is discharged to enable the delay judging circuit 250 to output the low level first signal Sdj at the time point t9. Then, the logic level of the control signal Scl is changed to high. The rising/falling edge detecting circuit 261 is triggered by the high level control signal Scl, so as to generate a pulse signal to reset the RS flip-flop 262 to make the third signal Sq changed to high level. Thus, in the period between time points t9 and t10, the logic level of the control signal Scl is high, and the OR gate 264 outputs the high level selecting signal Sel to enable the multiplexer 269 to select the signal received from the first selecting input end s1 as the logic control signal Slo, i.e. to make the driving signal Sdr stay high. At time points t10 and t11, the short-circuit condition has not been recovered, and thus the operations at time points t7 and t8 will be repeated.

As mentioned above, the driving circuit in the present invention may adjust the level of the driving signal Sdr according to the logic level of the control signal Scl under the abnormal conditions. That is, when the logic level of the control signal Scl is high and the abnormal condition induces an over-low driving signal Sdr lasting longer than the predetermined time period, the driving-stage circuit 220 of the present invention may change the level of the driving signal Sdr to the level with respect to the low logic level of the control signal Scl. On the other hand, when the logic level of the control signal Scl is low and the abnormal condition induces an over-high driving signal Sdr lasting longer than the predetermined time period, the driving-stage circuit 220 of the present invention may change the level of the driving signal Sdr to the level with respect to the high logic level of the control signal Scl. Moreover, the driving circuit provided in the present invention may repeatedly detect the condition of the driving circuit to make sure whether the abnormal condition has been resolved or not according to the variation of the logic level of the control signal Scl, and the driving circuit may recover its ordinary operation after the abnormal condition has been resolved.

In addition, for a capacitive load, such as the MOSFET, a large peak current usually exists in the load, and the level of the driving signal cannot be adjusted to a target level, right after the load is driven or the driving state is changed. The conventional detecting methods, such as a method of detecting a current flowing through the load, cannot correctly determine the abnormal condition. In contrast, the present invention determines the abnormal condition based on the variation of voltage levels of the driving signal and has a delay time to prevent misjudgment, and thus is especially suitable for the capacitive load.

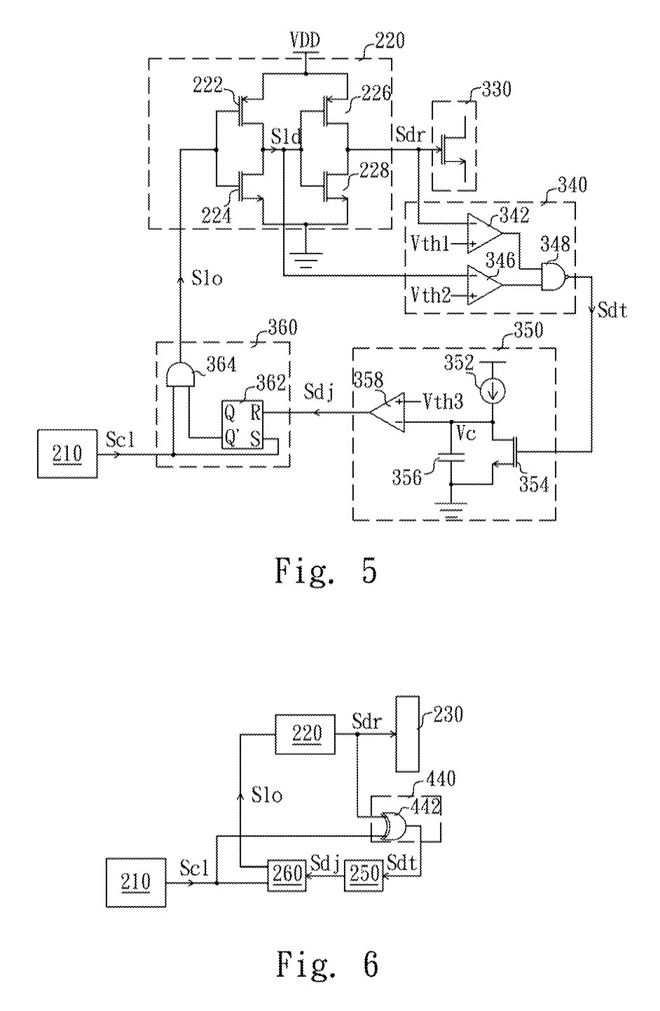

The present invention may be used to protect the driving circuit only merely with respect to a signal abnormal condition, such as short-circuit with respect to the power source, short-circuit with respect to the ground, or one-way overload, thereby meeting the characteristics of the load. For example, a dual-way overload protection may result in driving error for the MOSFET. FIG. 5 is a circuit diagram of a driving circuit in accordance with a second embodiment of the present invention. In contrast with the embodiment in FIG. 3, the present embodiment as shown in FIG. 5 adopts the comparator to replace the inverters in the driving signal detecting circuit 240 and the delay judging circuit 250, thereby setting adequate determining levels according to actual needs. In the present embodiment, the load 330 is a MOSFET, and the most well known abnormal conditions for the MOSFET, the short circuit with respect to ground and the over-loaded event, is described in the below.

The driving signal detecting circuit 340 includes two comparators 342 and 346 and a NAND gate 348 for detecting the level of the driving signal Sdr to determine a level of the load error signal Sdt. An inverting input of the comparator 342 receives the driving signal Sdr, and a non-inverting input thereof receives a first reference voltage Vth1, and the output thereof is coupled to the NAND gate 348. The inverting input of the comparator 346 receives the second signal Sld, and the non-inverting input thereof receives a second reference voltage Vth2, and the output thereof is coupled to the NAND gate 348. Under a normal operation, the second signal Sld and the driving signal Sdr have opposite phases, and thus the NAND gate 348 outputs the high level load error signal Sdt, which indicates that the condition of the load 330 is normal in the present embodiment. However, as the load 330 is short-circuited with respect to ground or overloaded, the second signal Sld is at the low level, and the comparator 346 may output the high level signal, but the driving signal Sdr cannot reach to the level higher than the first reference voltage Vth1, and thus the comparator 342 may also output the high level signal such that the NAND gate 348 outputs the low level load error signal Sdt representing that the load 330 has an abnormal condition.

The delay judging circuit 350 includes a current source 352, a reset switch 354, a delaying capacitor 356, and a comparator 358 for determining whether a period of the load error signal Sdt being at the low level lasts longer than a predetermined time period. The current source 352, the delaying capacitor 356, and the comparator 358 serve as a timing unit. If so, a first signal Sdj is generated. The inverting input of the comparator 358 is coupled to the delaying capacitor 356, and the non-inverting input thereof receives a third reference voltage Vth3, so as to generate the first signal Sdj. Under a normal operation, the NAND gate 348 outputs the high level load error signal Sdt to enable the reset switch 354 to be turned on, such that the capacitor voltage Cv of the delaying capacitor 356 will be lower than the third reference voltage Vth3 and the high level first signal Sdj is generated. As an abnormal condition occurs, the driving signal detecting circuit 340 generates the low level load error signal Sdt to cut off the reset switch 354, and the current source 352 begins to charge the delaying capacitor 356 to increase the capacitor voltage Cv. When the delaying capacitor 356 has been charged for longer than the predetermined time period, the level of the capacitor voltage Cv of the delaying capacitor 356 exceeds the third reference voltage Vth3, thus making the first signal Sdj changed to the low level.

The logic control circuit 360 is coupled to the control circuit 210, the delay judging circuit 350, and the driving-stage circuit 220, and includes a RS flip-flop 362 and an AND gate 364. The reset input R of the RS flip-flop 362 receives the first signal Sdj, and the set input S receives the control signal Scl, and the inverted output Q′ is coupled to an input of the AND gate 364. The AND gate 364 also receives the control signal Scl for generating the logic determining signal Slo according to the output of the SR flip-flop 362 and the control signal Scl. The logic control circuit 360 may output the low level logic determining signal Slo after receiving the low level first signal Sdj, which indicates the abnormal condition lasting longer than the predetermined time period, and the control signal Scl with the high logic level, so as to enable the driving signal Sdr to stay at low to prevent the continuous abnormal condition from damaging the circuit. When the logic level of the control signal Scl is changed to low, the RS flip-flop 362 recovers to output the high level output signal at the inverted output Q′ to enable the driving signal detecting circuit 340 to redetect whether the load 330 has any abnormal condition.

In the aforementioned two embodiments, the driving signal detecting circuit detects the first driving unit of the driving-stage circuit and the driving signal Sdr to determine whether the load has abnormal conditions or not. In fact, the driving signal detecting circuit may also execute the aforementioned judgment based on the detection of the driving signal Sdr and the control signal Scl directly. FIG. 6 is a circuit diagram of a driving circuit in accordance with a third embodiment of the present invention. In contrast with the embodiment shown in FIG. 3, the driving signal detecting circuit 440 in the present embodiment has a XOR gate 442. Under a normal operation, the control signal Scl and the driving signal Sdr have to be both high or low. However, as the abnormal condition occurs, the control signal Scl and the driving signal Sdr will be at the opposite phases and the XOR gate 442 may output the high level load error signal Sdt to indicate the abnormal condition. The operations of the delay judging circuit 250 and the logic control circuit 260 are identical to those described in the embodiment of FIG. 3, and thus are not described again herein.

The aforementioned embodiments are described based on the example in which the normal operation is recovered after the determination of the abnormal condition has been released. However, in actual practice, the load may be damaged during the abnormal condition and cannot be recovered. To solve such a problem, the logic control circuit of the present invention may integrate a counting circuit to count the number of the first signals Sdj received, and after reaching a predetermined number of times, such as 36 times, the logic control circuit may stop the driving-stage circuit until the driving-stage circuit is enabled by the other circuit, such that the other undesired circuit issues due to the repeated attempt to drive the load can be prevented.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A driving protection circuit, utilized for protecting a driving circuit which controls a level of a driving signal based on a logic level of a control signal having a first logic level and a second logic level for driving a load, the driving protection circuit comprising:
a driving signal detecting circuit for detecting the level of the driving signal, and generating a load error signal representing an abnormal condition of the load;
a delay judging circuit coupled to the driving signal detecting circuit for generating a first signal when the load error signal represents that the load has the abnormal condition lasting longer than a predetermined time period; and
a logic control circuit coupled to the delay judging circuit and the driving circuit for deciding whether to adjust the level of the driving signal or not according to the first signal;
wherein the logic control circuit adjusts the level of the driving signal to a level corresponding to the control signal at the second logic level when the control signal is at the first logic level and the load has the abnormal condition lasting longer than the predetermined timed period.

2. The driving protection circuit of claim 1, wherein the driving signal detecting circuit determines that the load has the abnormal condition when the level of the driving signal is lower than a first predetermined level, or higher than a second predetermined level.

3. The driving protection circuit of claim 2, wherein the driving signal detecting circuit includes an inverter or a comparator for determining whether the load has the abnormal condition or not according to the level of the driving signal.

4. The driving protection circuit of claim 2, wherein the load is a transistor switch which has a control end coupled to the driving circuit, and a state of the transistor switch is changed according to the driving signal.

5. The driving protection circuit of claim 1, wherein the delay judging circuit includes a timing unit for determining whether the abnormal condition lasts longer than the predetermined time period, and the timing unit is reset when the logic level of control signal is changed.

6. The driving protection circuit of claim 1, wherein the driving circuit includes a first driving unit and a second driving unit, the first driving unit generating a second signal according to the control signal, the second driving unit generating the driving signal according to the second signal, and the delay judging circuit determines whether the driving signal lasts longer than the predetermined time period based on a timing of the second signal.

7. The driving protection circuit of claim 6, wherein the driving signal detecting circuit includes an inverter or a comparator for determining whether the load has the abnormal condition or not according to the level of the driving signal.

8. The driving protection circuit of claim 6, wherein the load is a transistor switch which has a control end coupled to the driving circuit, and a state of the transistor switch is changed according to the driving signal.

9. The driving protection circuit of claim 1, wherein the driving signal detecting circuit includes an inverter or a comparator for determining whether the load has the abnormal condition or not according the level of the driving signal.

10. The driving protection circuit of claim 1, wherein the load is a transistor switch which has a control end coupled to the driving circuit, and a state of the transistor switch is changed according to the driving signal.

11. The driving protection circuit of claim 1, wherein the logic control circuit counts a number of the abnormal conditions lasting longer than the predetermined time period and controls the driving circuit to stop generating the driving signal when the number of the abnormal conditions reaches a predetermined number.

12. A driving circuit with output protection, comprising:
a control circuit for generating a control signal having a first logic level or a second logic level;
a driving stage circuit for generating a driving signal and controlling a level of the driving signal with respect to the logic level of the control signal for driving a load; and
a driving protection circuit coupled to the control circuit and the driving stage circuit for determining whether the driving signal which is lower than a first predetermined level lasts longer than a predetermined time period or not when the control signal is at the first logic level, and if so, controlling the driving stage circuit to adjust the level of the driving signal to a level corresponding to the control signal at the second logic level.

13. The driving circuit with output protection of claim 12, wherein the driving protection circuit includes a timing unit counted for a time period of the driving signal lower than a first predetermined level, and the timing unit is reset when the logic level of the control signal is changed.

14. The driving circuit with output protection of claim 12, wherein the driving protection circuit includes:
a driving signal detecting circuit for detecting the level of the driving signal, and generating a load error signal representing a condition of the load;
a delay judging circuit coupled to the driving signal detecting circuit for generating a first signal when the load error signal represents that the load has the abnormal condition lasting longer than a predetermined time period; and
a logic control circuit coupled to the delay judging circuit and the driving circuit for deciding whether to adjust the level of the driving signal or not according to the first signal.

15. The driving circuit with output protection of claim 12, wherein the load is a capacitive load.

16. A driving circuit with output protection comprising:
a control circuit for generating a control signal having a first logic level or a second logic level;
a driving stage circuit for generating a driving signal and controlling a level of the driving signal with respect to the logic level of the control signal for driving a load; and
a driving protection circuit coupled to the control circuit and the driving stage circuit for determining whether the driving signal lower than a second predetermined level lasts longer than a predetermined time period or not when the control signal is at the second logic level, and if so, controlling the driving stage circuit to adjust the level of the driving signal to a level corresponding to the control signal at the first logic level.

17. The driving circuit with output protection of claim 16, wherein the driving protection circuit includes a timing unit counted for a time period of the driving signal lower than a second predetermined level, and the timing unit is reset when the logic level of the control signal is changed.

18. The driving circuit with output protection of claim 16, wherein the driving protection circuit includes:
a driving signal detecting circuit for detecting the level of the driving signal, and generating a load error signal representing a condition of the load;
a delay judging circuit coupled to the driving signal detecting circuit for generating a first signal when the load error signal represents that the load has the abnormal condition lasting longer than a predetermined time period; and
a logic control circuit coupled to the delay judging circuit and the driving circuit for deciding whether to adjust the level of the driving signal or not according to the first signal.

19. The driving circuit with output protection of claim 16, wherein the load is a capacitive load.
